(19) United States
(12) Patent Application Publication
(10) Pub. No.: US 2013/0088583 A1
(43) Pub. Date: Apr. 11, 2013

(54) Handheld Iris Imager

(71) Applicants: Malcolm J. Northcott, Felton, CA (US); J. Elon Graves, Los Gatos, CA (US); Howard Dando, Rio Del Mar, CA (US)

(72) Inventors: Malcolm J. Northcott, Felton, CA (US); J. Elon Graves, Los Gatos, CA (US); Howard Dando, Rio Del Mar, CA (US)

(73) Assignee: AOPTIX TECHNOLOGIES, INC., Campbell, CA (US)

(21) Appl. No.: 13/268,906

(22) Filed: Oct. 7, 2011

(51) Int. Cl. H04N 7/18

(52) U.S. Cl. 348/78; 348/E07.085

(57) ABSTRACT

A portable, hand held iris imaging system captures iris images that may be used in biometric identification. The system includes an illumination source for illuminating a subject's eye and a camera to capture light reflected from the subject's eye. An optical element positioned between the illumination source and the camera focuses light reflected from the subject's eye onto the camera. A controller receives the captured image and provides it to a display. If the system is not correctly positioned for iris image capture, the display may also provide visual feedback regarding how the system can be properly repositioned. The system includes a housing with a portable form factor so that it may be easily operated.

### BACKGROUND OF THE INVENTION

1. Field of the Invention

This application relates generally to portable biometric identification systems, and more specifically relates to portable iris imaging systems.

2. Description of the Related Arts

Iris imaging has numerous advantages to other types of biometric identification. Whereas human faces naturally change with age and human fingerprints can be affected by manual labor, the human iris remains constant with age and is generally well protected from wear and tear. Iris imaging for biometric purposes is also advantageous because it can be performed quickly and does not require physical contact with the subject. These aspects are particularly important if the iris imaging is being performed in a hostile environment, such as a warzone, or on uncooperative subjects.

Existing iris imaging systems suffer from a number of problems, including difficulties that increase the amount of time required to capture an iris image of sufficient quality for biometric identification. Existing iris imaging systems over-rely on the operator of the system to identify the eye for iris image capture. Existing iris imaging systems also use a fixed focal length lens. Any time the iris imaging system is not placed at the correct distance, iris image quality suffers due to lack of focus, and as a result may need to be retaken. Both of these issues may be solved by taking more time to capture the iris image, however taking the extra time may increase the danger posed to the operator if they working in a hostile environment.

Existing iris imaging systems are also problematic in that they are only operable in very close proximity to the subject. Requiring close proximity to the subject makes the iris imaging system more intrusive and difficult to use. In dangerous situations, this amplifies the potential dangers associated with capturing the iris image, particularly if the subject is at risk of causing the operator personal harm.

Existing iris imaging systems also suffer from problems associated with contamination of iris images by reflections of ambient light from the environment. The surface of the eye is roughly spherical with a reflectivity of a few percent, and as a result it acts like a wide angle lens. The surrounding environment is thus reflected by the surface of the eye, producing a reflected image which overlies the iris image. This reflected image can significantly degrade the accuracy of an iris image. Existing iris imaging systems have attempted to solve this problem by limiting the capture of images to indoor areas or by decreasing the distance between the system and the subject. Both of these solutions decrease the ease of use of the iris imaging system. In hostile environments, both solutions negatively affect the safety of the operator.

Recent advances in iris imaging technology have enabled some iris imaging systems to be built in a portable form factor. However, existing portable iris imaging systems have major drawbacks that decrease their effectiveness, particularly in hostile environments. Existing portable iris imaging systems are bulky, and as a result require the full attention of the operator, as well as both of the operator's hands, in order to function. In hostile environments, this compromises the safety of the operator.

### SUMMARY OF THE INVENTION

The present invention overcomes the limitations of the prior art by providing a portable, handheld iris imaging system that is operable in all light conditions and at long standoff distances. The system is easy and quick to operate, even in dangerous environments. The system is operable with only a single hand, increasing ease of use and freeing the operator's other hand for other tasks.

The iris imaging system provides, via a display, visual feedback regarding the positioning of the system. The visual feedback assists the operator in positioning the system for iris image capturing, decreasing the time and difficulty usually associated with obtaining iris images. The iris imaging system includes an illumination source and a controller which illuminate the subject's eyes near and during image capture to remove contamination of iris images from ambient light. The system further includes an optical element with a variable focus, increasing the quality of iris images, thereby minimizing the frequency with which iris images need to be recaptured.

Iris images for each of a subject's eyes may be captured simultaneously or sequentially, depending upon the implementation. In addition to capturing iris images, the system may also capture face images, which also be used in biometric identification. The system may be further augmented to capture other biometric identifiers. For example, a fingerprint scanner may be added to capture fingerprints.

The iris imaging system may be constructed as a stand-alone device with a single camera that captures both face and iris images. Alternatively, the iris imaging system may be constructed with two subsystems that may be coupled together. The first subsystem allows for iris image capture, and comprises an iris camera, filter, illumination source, and iris capture optical element. The second subsystem comprises a second camera for capturing face images, and a display. The second subsystem may be, for example, a smartphone with a display or another similar device.

### BRIEF DESCRIPTION OF THE DRAWINGS

The teachings of the embodiments of the present invention can be readily understood by considering the following detailed description in conjunction with the accompanying drawings.

FIG. 1 illustrates a portable, handheld iris imaging system with a single camera, according to one embodiment.

FIG. 2 illustrates a portable, handheld iris imaging system with an iris image capture camera and a face image capture camera, according to one embodiment.

FIG. 3 is a flowchart illustrating a process for capturing an iris image using a portable, handheld iris imaging system, according to one embodiment.

FIG. 4 is a flowchart illustrating the process for capturing separate iris images of each of a subject's eyes sequentially, according to one embodiment.

FIG. 5a is illustrates a side view of a portable, handheld iris imaging system that can be operated with one hand, according to one embodiment.

FIG. 5b is illustrates a back view of a portable, handheld iris imaging system that can be operated with one hand, according to one embodiment.

### DETAILED DESCRIPTION OF EMBODIMENTS

### General Overview and Benefits

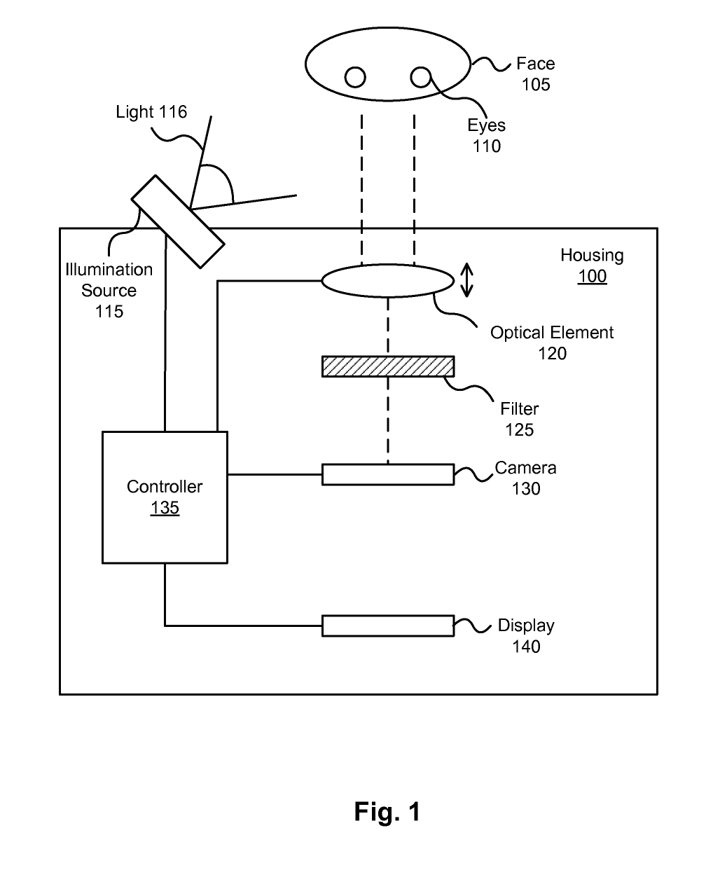

FIG. 1 illustrates a portable, handheld iris imaging system 100 with a single camera 130, according to one embodiment. The system 100 includes a housing 100, an illumination source 115, a focusing optical element 120, a filter 125, a camera 130, a controller 135, and a display 140. The system 100 is pointed towards the face 105 of a subject whose iris images are to be captured. The illumination source 115 illuminates the subject's eyes 110 with light 116. A portion of the light 116 reflected from the subject's eyes 110 is transmitted back towards the optical element 120. The optical element 120 focuses the reflected light onto a plane located at the surface of the camera 130. In between the optical element 120 and the camera 130, the reflected light passes through a band pass filter 125 that passes the wavelengths of light that will constitute the iris image and rejects other wavelengths. A controller 135 controls the operation of the active elements of the system 100, including the illumination source 115, the optical element 120, the camera 130, and the display 140. The display 140 provides the user with visual feedback that assists in image capture, and can also display the captured iris images as well as the results of a biometric identification or authentication.

The illumination source 115 is located on an exposed face of the system 100 that is directed towards the subject during image capture. The illumination source 115 is capable of illuminating the subject's eyes 110, as well as the subject's face 105. The illumination source 115 may be located on-axis with respect to the camera 130, such that the light transmitted from the illumination source 115 travels a similar path to light reflected from the subject's eye. In this case, the illumination source 115 may also include waveguides for projecting the light onto the axis of the reflected light. On-axis illumination increases the amount of light that is reflected from the subject's eye 110 back towards the camera 130. Alternatively, the illumination source may be located off-axis with respect to the camera 130. Off-axis illumination minimizes glint reflections that may otherwise contaminate the iris image. The illumination source 115 may be constructed using any light source that can produce the wavelengths at which the iris image will be captured. Examples include light emitting diodes, lasers, hot filament light sources, or chemical light sources.

The camera 130 captures the iris image by receiving light 116 from the illumination source 115 that has been reflected from the subject's eyes 110. In order to have sufficient resolution to adequately distinguish irises, the iris images captured by the camera 130 should have at least 200 resolution elements across each iris image. This may be met, for example, by having at least 200 pixels present in the diameter of each iris image. The camera 130 may include a CMOS image sensor. In one example, the CMOS image sensor is capable of capturing 5 megapixels (5,000,000 pixels) in each image. In another example, the CMOS image sensor is capable of capturing 9 megapixels in a single image. The camera may include other types of image sensors, for example a charge coupled device (CCD).

In one implementation, the camera 130 captures images within the infrared wavelength range of 750 nanometers (nm) to 900 nanometers, inclusive. Correspondingly, the illumination source 115 produces illuminating light 116 within this wavelength range. In some cases, the illumination source 115 illuminates within a few nanometers of a single wavelength, for example 750, 800, or 850 nm.

The illumination source may also produce light at two differing wavelengths or wavelength bands, for example light at or around 750 nm as well as light at or around 850 nm. In some subjects, the production of shorter wavelengths of light can enhance the scalera boundary that defines the boundary between iris tissue and the white of the eye. Therefore, by producing light at multiple wavelengths, the camera 130 can improve segmentation used in determining iris information, while simultaneously capturing an image of the iris at 850 nm.

In order to improve the quality of the iris images, a band-pass filter 125 rejects wavelengths of light that are outside of a specified range and passes light within the specified range. For example, if the illumination source 115 produces light 116 at 750 nm, the band pass filter 125 may be designed to transmit light between 735-765 nm. In instances where the illumination source 115 provides light at multiple wavelengths, the filter 125 may be a dual band-pass filter which passes multiple ranges of wavelengths. For example, if the illumination source emits light at wavelengths of 750 and 850 nm, the filter 125 may be designed to pass light between the wavelengths of 735-765 nm and 835-865 nm.

A controller 135 controls the operation of the illumination source 115 and camera 130 to synchronize the capture of iris images with the illumination of the subject's eyes. In order to remove contamination from ambient light and capture a high quality iris image, the controller 135 activates the illumination source 115 at a very high brightness (or intensity) for a short amount of time and causes the camera 130 to capture the iris image during that brief interval. Typically, the interval of the illumination is between 1 to 10 ms, inclusive. A high intensity illumination increases the amount of light 116 reflected from the iris, increasing the quality of the iris image. The shorter the interval of illumination, the higher in intensity the illumination may be without causing damage to the subject's eyes 110.

Alternatively to illuminating the subject's eyes in a single pulse, the controller 135 may cause the illumination source to illuminate the subject's eyes 110 multiple times within a short interval. For example, each of the several pulses may be approximately 1-2 ms in length, spaced over the course of 10-12 ms. In conjunction with the pulsed illumination, camera 130 exposure to capture an iris image is synchronized with the pulsing in order to reject any background light that falls on the camera other than during the flash illumination. An iris image may be captured during each pulse.

Pulsing illumination allows a large amount of light 116 to be reflected off the subject's eyes 110 without causing injury. Pulsing allows the illumination source 115 to achieve a power level of 5 mW per square cm at the subject's eye 110. The larger the amount of light 116 that can be reflected from the subject's eye 110, the higher the quality of the resulting iris image at the camera 130. In one case, a first few pulses of light in the visible wavelength range can cause the subject's eye to react, causing the iris to contract, thereby increasing the visible surface of the iris that will be captured by the camera 130 during subsequent pulses. This, in turn, results in improvements in the iris image quality.

An optical element 120 is located in the optical path of the light 116 reflected from the subject's eyes 110, in between the subject and the camera 130. The optical element may be located either between the filter 125 and the camera 130 (not shown), or closer to the subject relative to both the camera 130 and the filter 125, as shown in FIG. 1. The optical element focuses the light 116 reflected from the subject's eyes 110 onto a plane located at the surface of the camera 130. By focusing the reflected light, the camera 130 is better able to capture a clear iris image.

The optical element 120 is connected to the controller 135 which controls the focus of the optical element 120. The controller 135, in conjunction with the optical element 120, may use any one (or more than one) of several techniques to adjust the focus by changing the location of the optical element 120 with respect to the camera 130. These techniques include, but are not limited to: dithering the location of the optical element, performing time of flight measurements with a range finder (not shown) configured to receive a signal from an optical or acoustic source (also not shown), using stereo imaging, and projecting structured light. In some cases, the focus of the optical element 120 is offset to allow for chromatic aberration between the wavelength of light used for focusing (for example, the wavelength of light used by the range finder to determine the distance to the subject's eyes), and the wavelength of light 116 used for iris imaging.

The system 100 may capture an iris image for each eye 110, one eye at a time. Capturing one iris image at a time allows the system to adjust the focus for each eye individually thereby improving the quality of each iris image, and further allows the system 100 to accommodate users who are not directly facing the camera 130. Alternatively, the system 100 may capture iris images for both eyes simultaneously. Capturing both eyes 110 simultaneously reduces the amount of time required to capture iris images for both eyes 110.

The system 100 may also capture an image of a subject's face 105 to use as a biometric identifier. In one example, face images consist of at least 200 resolution elements between the eyes of subject in order to have sufficient resolution for use as a biometric identifier. In order to capture face images, in one case the controller 135 causes the illumination source 115 to illuminate the subject's face 105 with a low amount of light as compared to the amount of light used to illuminate the subject's eyes for iris image capture. In some implementations, the system 100 consists of a movable structure (not shown) that repositions the filter 125 out of the optical path of the light reflected from the subject's face 105. If the filter 125 is repositioned in this manner, the face image captured by the camera 130 may consist of additional light (e.g., ambient light) from wavelengths outside the spectrum provided by the illumination source 115. In some cases, the movable structure may place a second “face image” band pass filter (not shown) into the optical path of the reflected light, thereby allowing control over which wavelengths of light are used make up the face image.

In addition to iris images and face images, system 100 may also capture other types of biometric identifiers. For example, system 100 may be augmented with a fingerprint reader to allow for capture of fingerprint biometric identifiers. Any combination of biometric identifiers for a single subject may be combined into a biometric file. Optionally, the biometric file may be cryptographically signed to guarantee that the individual biometric identifiers that make up the biometric file cannot be changed in the future.

The display 140 displays images captured by the camera 130, the results of a biometric identification, or other information. The display 140 is connected to the controller 135. The controller receives 135 images from the camera 130 and transmits them to the display 140. When not actively capturing face or iris images for use as biometric identifiers, the camera 130 may be constantly capturing an image or video feed, and transmitting those images to the display 140 through the controller 135. The image feed provides constant feedback to the user of the system 100 regarding what the camera 130 sees, in order to facilitate the capture of iris and face images.

The controller 135 may augment the image feed displayed by the display 140 with visual indications that assist the operator in bringing the system 100 and/or the subject's face 105 or eyes 110 into correct positioning for the capture of face and iris images. The controller 135 determines whether a subject can be located. The controller 135 may include a subject location image processing algorithm to determine if the system 100 is roughly pointed towards a subject. The controller 135 may provide a visual indication on the display 140 if a subject cannot be located within the field of view of the camera 130. The controller 135 may also provide to the display 140 visual indications of the progress of the subject location algorithm. For example, when the subject is found within the field of view of the camera 130, a reward indicator (for example a green dot or outline around the subject) may be displayed, which differs from another visual indicator (for example a yellow dot or arrows pointing towards a subject) which indicates that a subject has not yet been found within the field of view of the camera 130.

The controller includes a face finding image processing algorithm for locating a face 105 as well as the eyes 110 on the subject. The face finding algorithm may run continuously, it may be triggered by finding a subject within the field of view of the camera 130, and/or it may be triggered by a determination that the subject is within a specified distance of the of the system 100, as determined by a range finder (not shown) for example. The controller 135 may provide to the display 140 visual indications of the progress of the face finding algorithm. For example, when the face or eyes are found, a reward indicator (for example another green dot or outline around the subject's face or eyes) may be displayed, which differs from another visual indicator (for example a second yellow dot) which indicates that the subject's face or eyes have not yet been found.

The visual indications may include screen overlays on the display 140 which overlay the images captured by the camera 130. These screen overlays may direct the operator to reposition the iris imaging system to help center the subject in the field of view. For example arrows may be used to indicate which direction to point the iris imaging system 100. The screen overlays may also include boxes indicating where the controller determines the location of the subject's eyes 110 are within the image. In some cases, the boxes around the subject's eyes will change colors, providing feedback regarding whether the subject is within the correct distance range for iris image capture. For example, red may indicate that the subject is too close to the camera, white may indicate that the subject is too far from the camera, and green may indicate that the subject is within the correct range for iris image capture. In other implementations, the system 100 may include speakers (not shown) to provide audible indicators that supplement or replace the visual indicators.

The controller 135 may also be connected to a range finder (not shown) configured to determine the distance to the subject. In conjunction with the face finding algorithm, the range finder may also determine the distance to each of the subject's eyes 110, which may vary slightly from the distance to the subject generally. The controller 135 may provide to the display 140 visual indications of whether the subject's eyes 110 or face 105 are within the proper range for image capture. In one case, the system 100 is able to capture iris images if the subject is between 17.5 and 35 cm, inclusive, from the system 100. In one example, system 100 may also include physical restraints that are placed in contact with the subject to ensure they are the correct distance from the system 100 for iris image capture.

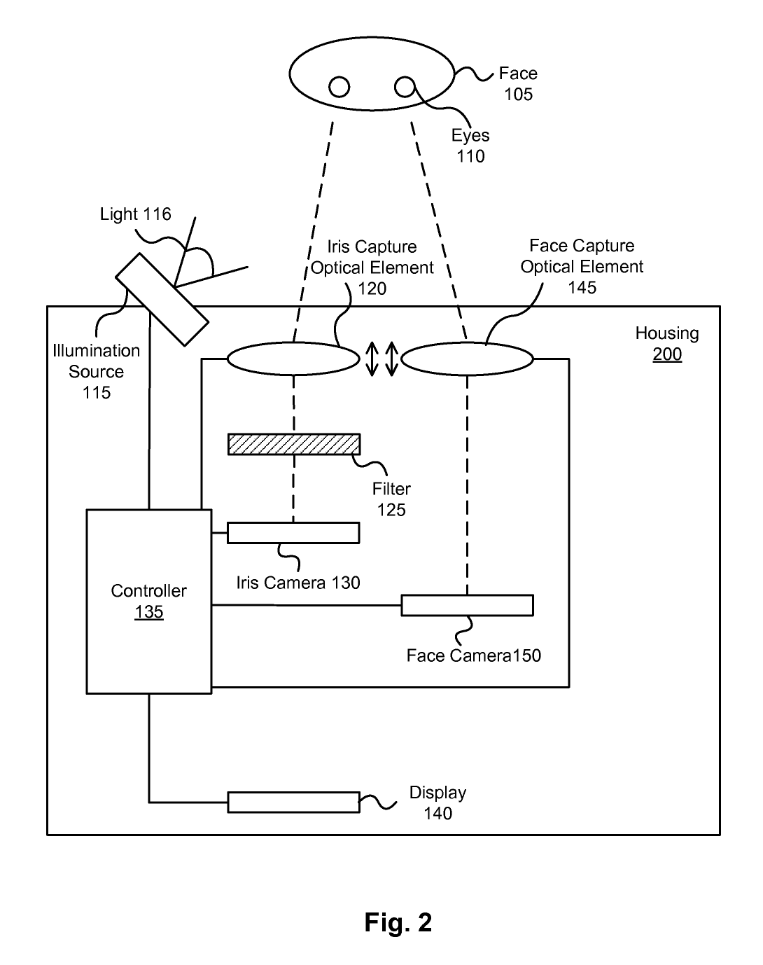

FIG. 2 illustrates a portable, handheld iris imaging system 200 with a housing 200, an iris image capture camera 130 and a face image capture camera 150, according to one embodiment. Rather than having a single camera 130, the iris imaging system 200 has both an iris imaging camera 130 configured specifically for capturing iris images, as well as a face camera for capturing face images and assisting in positioning the system 200 for capturing iris images. In one case, iris imaging system 200 also has two separate optical elements, an iris capture optical element 120 configured to focus light 116 reflected from the subject's eyes 110 to the iris camera 130, as well as a face capture optical element 145 configured to focus light 116 from the subject's face as well as the subject more generally.

The filter 125 is positioned in the optical path of light traveling into the iris camera 130. The filter 125 may be located next to the iris camera 130, or positioned between the subject and the iris optical element 120. In the arrangement shown in FIG. 2, the filter 125 does not filter light entering the face camera 150. In some cases, the iris imaging system 200 may additionally comprise a second filter (not shown) to filter the wavelengths of light entering the face camera 150.

In iris imaging system 200, the two cameras perform different functions. The controller 135, in conjunction with the face camera 150, determines the location of a subject, determines the location of the subject's face and eyes, and in conjunction with the display 140 provides the visual feedback to the iris imaging system 200 regarding how the positioning of the device or the subject may be adjusted to better capture face and iris images. Together, the face camera 150, illumination source 115, controller 135 capture face images that may be used as biometric identifiers. In one case, the iris imaging system 200 includes a second illumination source (not shown) which illuminates the subject's face 105 for the capture of face images. Once the subject's eyes have been located, the iris camera 130, in conjunction with the illumination source 115, iris optical element 120, and controller 135 capture iris images.

In one embodiment, the iris imaging system 200 may be constructed in two separate subsystems. The first subsystem consists of the face camera 150, the display 140, and optionally a second filter, second illumination source, and second optical element 145. The first subsystem may be constructed in the form of a commercial portable camera device, for example a commercial digital camera with an LCD screen, or a smartphone device that includes a display and a camera.

The second subsystem comprises an iris optical element 120, filter 125, iris camera 130, controller 135, and illumination source 115. The second subsystem may be constructed in such a fashion that it can be removable from the first subsystem, as an additional component that augments the underlying functionality of the first subsystem. For example, the second subsystem may be an attachment that augments the functionality of a smartphone.

In one case, a connector (not shown) may be coupled between the controller 135 and an internal computer of the first subsystem. For example, the connector may be coupled to a data input port of the first subsystem. In this manner, images captured by the iris camera 130 may be transmitted to the controller 135, through the connector to the display 140. In another case, the controller 135 is located inside the first subsystem rather than the second subsystem. In this case, a connector couples the controller 135 of the first subsystem with the individual components of the second subsystem.

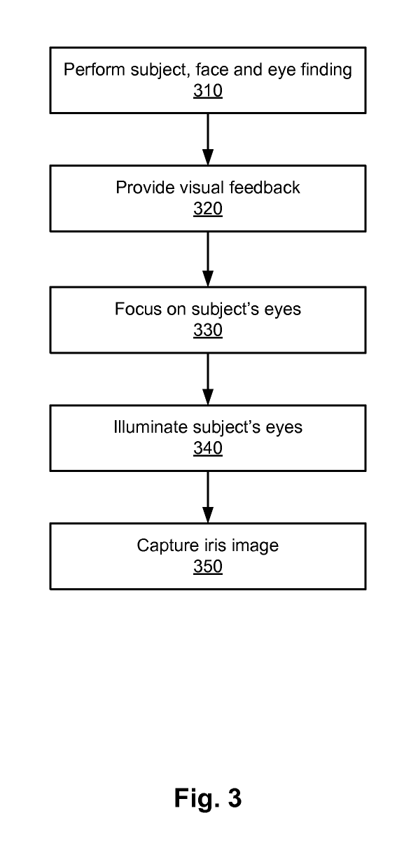

FIG. 3a is a flowchart illustrating a process for capturing an iris image using a portable, handheld iris imaging system 100, according to one embodiment. The operator of the iris imaging system 100 activates the iris imaging system 100 and points the iris imaging system 100 towards a subject. The camera 130 of the iris imaging system 100 captures images in a feed and transmits them through the controller 135 to the display 140, so that the operator may view the scene captured by the camera 130. In one case, the image feed is captured by the camera 130 in a low resolution format to increase the speed at which images can be captured, thereby increasing the update rate of the image feed. For example, the image feed may be captured at a resolution of 640 by 480 pixels.

The subject finding algorithm determines 310 whether a subject is depicted in the images captured by the camera 130. If a subject is depicted, the face and eye finding image processing algorithm determines 310 the location of the subject's face 105 and eyes 110 within the captured images. If the subject or their face 105 or eyes 110 cannot be identified, the controller 135 provides the display 140 with visual feedback 320 regarding how the iris imaging system 100 may be repositioned to better capture the subject and their face 105 and eyes 110. When the iris imaging system 100 has been properly positioned so that an iris image may be captured, the display 140 provides 330 further visual feedback, e.g., a visual reward, indicating to the operator that the iris image may be captured and that the iris imaging system 100 does not need to be further repositioned.

Prior to image capture, the controller 135 adjusts the optical element 120 to focus 350 the eye with respect to the camera 130. The focus may be adjusted by the controller 135 automatically when the iris imaging system 100 receives an indication to capture an iris image. The controller 135 uses the results of the face and eye finding algorithm regarding the location of the subject's eyes 110 to determine which portion of the field of view captured by the camera 130 are used to capture the iris image. The camera 130 does not need to collect an image with all pixels of the camera 130 in order to capture the iris image. Instead, the controller 135 may pass the locations of the subject's eyes 110 to the camera 130 to capture a picture of the subject's eyes 110 only. This may involve, for example, providing the camera 130 with a particular sub array of pixels with which to capture an image.

The controller 135 instructs the illumination source 115 to illuminate 360 the subject's eyes 110 with light 116 of the specified wavelength. The controller 135 instructs the camera 130 to capture 370 an image of the subject's eyes 110. The iris image is captured at a high resolution in order to capture sufficient resolution elements for use in biometric identification. Depending upon the implementation, the iris images for each of the subject's eyes 110 may be captured sequentially or simultaneously. Upon capture of the iris image, the controller 135 compares the captured iris image against an International Organization for Standards (ISO) iris image quality metric to determine if the iris image is sufficient for use in biometric identification. The ISO image quality metric includes, for example, determinations regarding whether the image is sufficiently sharp, or whether any occlusions or glint reflections prevent the iris from being analyzed. If the iris image meets the requirements of the image quality metric, the display 140 optionally presents a visual indication that iris image capture was successful.

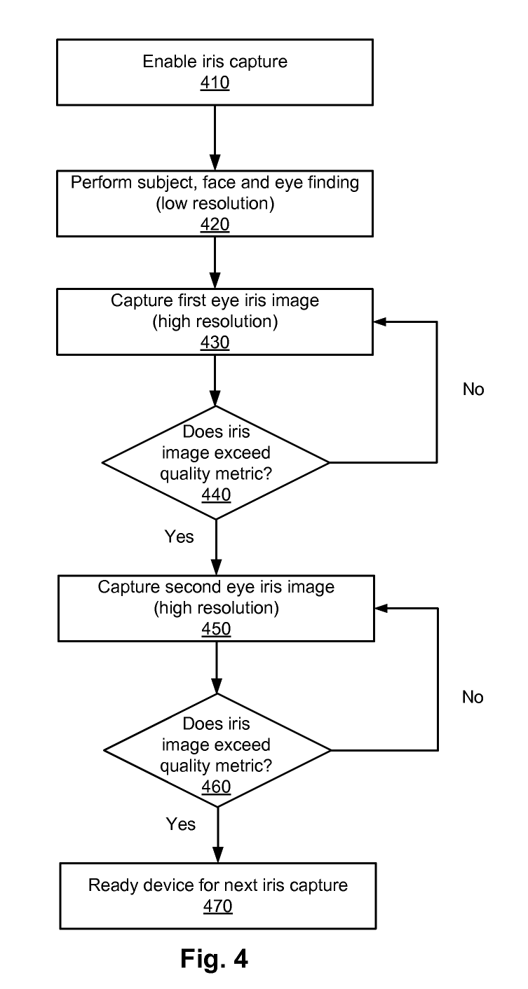

FIG. 4 is a flowchart illustrating the process for capturing separate iris images of each of a subject's eyes 110 sequentially, according to one embodiment. The iris imaging system 100 is activated in order to enable 410 iris image capture. The camera 130 captures an image feed at a low resolution. The controller 135 performs subject, face and eye finding 420 on the images captured in the feed in order to determine the location of the subject as well as their face 105 and eyes 110.

The controller 135 uses the location of the first of the subject's eyes 110 to control the optical element 120 to focus on the first eye. The controller activates the illumination source 115. At approximately the same time, the controller 135 provides the location of the subject's first eye to the camera 130 and instructs the camera 130 to capture 430 a first high resolution iris image of the first eye. The camera 130 uses the location provided by the controller 135 to minimize the size of the image captured by the camera 130, thereby decreasing the amount of time required to capture and process the image. The controller 135 compares the first iris image against the image quality metric 440 as described above. If the first iris image does not meet the image quality metric, the controller 135 causes the camera 130 to capture another iris image, or provides instructions to the display 140 to display a visual indication that the iris image for the first eye should be recaptured.

If the first iris image meets the image quality metric, the controller 135 uses the location of the subject's second eye to control the optical element 120 to focus on the second eye. The focus for the second eye may differ from the focus for the first eye. The controller 135 activates the illumination source 115. At approximately the same time, the controller 135 provides the location of the subject's second eye to the camera 130, and instructs the camera 130 to capture 450 a second high resolution iris image of the second eye. The controller 130 compares the second iris image against the image quality metric 460 as described above. If the second iris image does not meet the image quality metric, the controller 135 captures another iris image, or provides instructions to the display 140 to display 140 a visual indication that the iris image for the second eye should be recaptured. If the second iris image meets the image quality metric, the controller 135 instructs the display 140 to provide a visual indication that iris image capture was successful. The controller 135 then readies 470 the iris imaging system for the next iris image capture.

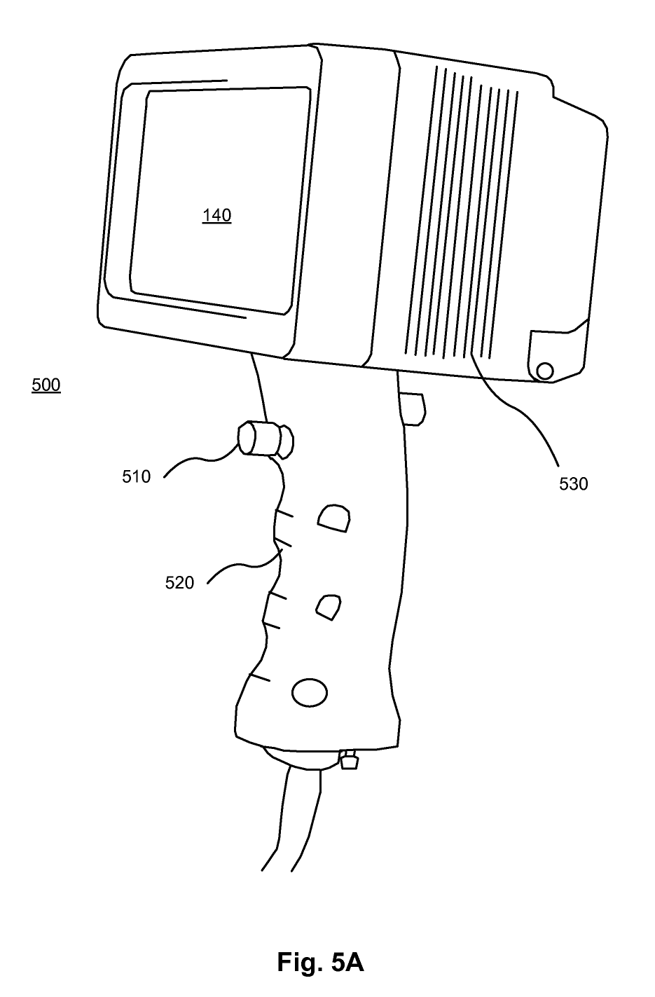

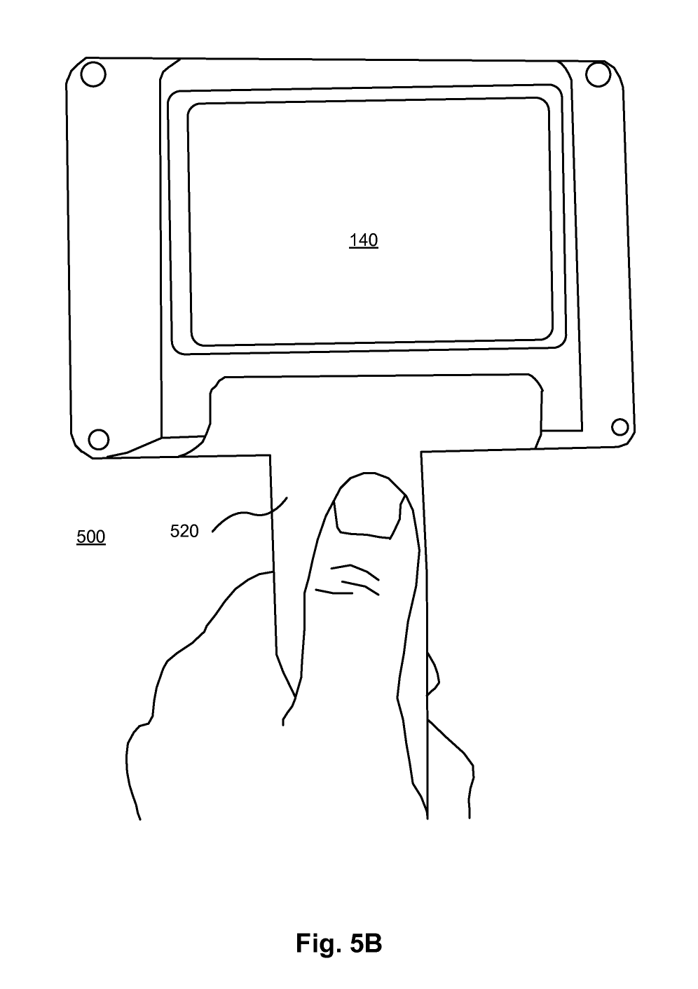

FIG. 5A is illustrates a side view of a portable, handheld iris imaging system 500 that can be operated with one hand, according to one embodiment. The iris imaging system 500 includes a button 510 (or trigger) that causes the iris imaging system to capture an iris image. The button 510 facilitates the operation of the iris imaging system with only a single hand, thereby decreasing the amount of operator intervention needed during the image capture process. The iris imaging system also includes a handle 520 to make it easier for the iris imaging system to be repositioned with a single hand. The iris imaging system 500 also includes a housing 530 containing the elements of the iris imaging system. FIG. 5B is illustrates a back view of a portable, handheld iris imaging system 500 that can be operated with one hand, according to one embodiment. In one example, the iris imaging system weighs less than 5 pounds. In another example, the iris imaging system weighs less than 3 pounds.

### Additional Considerations

Some portions of above description, for example with respect to the controller 135 and camera 130, describe the embodiments in terms of algorithms and symbolic representations of operations on information, or in terms of functions to be carried out by other components of the system, for example the motion of optical element 120. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. The described operations may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device, that manipulates and transforms data represented as physical (electronic) quantities within the computer system memories or registers or other such information storage, transmission or display devices.

The controller 135 may be specially constructed for the specified purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A portable, hand held iris imaging system comprising:
an illumination source configured to illuminate a subject's eye;
a camera configured to capture an image of an iris of the illuminated subject's eye with sufficient resolution for biometric identification;
an optical element positioned between the illumination source and the camera, the optical element configured to focus light reflected from the subject's eye onto the camera;
a display configured to display images captured by the camera; and
a housing containing the illumination source, the camera and the display, the housing having a portable form factor able to be held by a single human hand, and wherein a total weight of the iris imaging system is less than 10 pounds.

2. The system of claim 1 wherein the iris imaging system is configured to be operable with only a single hand.

3. The system of claim 1 wherein the illumination source produces light in a wavelength range of 750 nm to 900 nm, inclusive.

4. The system of claim 1 comprising a band pass filter positioned between the optical element and the camera, the filter configured to transmit a portion of the light reflected from the illuminated subject's eye towards the camera.

5. The system of claim 1 wherein the display is configured to display a visual indication indicating how to reposition the iris imaging system to capture the iris image.

6. The system of claim 1 comprising a controller configured to adjust a focus of the optical element.

7. The system of claim 1 comprising a controller configured to receive a face image from the camera and perform a face finding operation on the face image.

8. The system of claim 1 comprising a controller a configured to activate the illumination source to illuminate the subject's eye, instruct the camera to capture the iris image and receive the iris image from the camera.

9. The system of claim 8 wherein the controller is configured to activate the illumination source for approximately 1-10 milliseconds in order for the camera to capture the iris image.

10. The system of claim 8 wherein the controller is configured to activate the illumination source for a plurality of pulses, wherein each pulse is approximately 1-2 ms in order for the camera to capture the iris image.

11. The system of claim 8 wherein the controller is configured to activate the illumination source for a plurality of pulses, wherein each pulse creates approximately 5 mW per square cm of light at the subject's eye.

12. The system of claim 1 wherein the iris imaging system is capable of capturing the iris image at a standoff distance in the range of at least 17.5 to 35 centimeters, inclusive.

13. The system of claim 1 wherein the illumination source is configured to illuminate the subject's face and the camera is configured to capture an image of the illuminated subject's face.

14. An iris imaging system comprising:
an illumination source configured to illuminate a subject's eye;
a face camera configured to capture an image of the illuminated subject's face with sufficient resolution for biometric identification;
an iris camera configured to capture an image of an iris of the illuminated subject's eye with sufficient resolution for biometric identification;
an iris capture optical element positioned between the illumination source and the iris camera, the iris capture optical element configured to focus light reflected from the subject's eye onto the iris camera;
a housing containing the illumination source, the face camera, the iris camera and the display, the housing comprising a portable form factor able to held by a single human hand, and wherein a total weight of the iris imaging system is less than 10 pounds.

15. A method for capturing an iris image, comprising:
capturing a face image of a subject;
providing a visual indication of the location of the subject's eyes;
focusing, automatically, on the subject's eyes;
illuminating the subject's eyes with a light source contained in the housing;
capturing the iris image of the subject's eyes with sufficient resolution for biometric identification;
determining that the iris image exceeds an image quality metric; and
indicating that the iris image was successfully captured.

16. The method of claim 15, wherein the focusing, capturing, and determining comprises:
focusing, automatically, on a first of the subject's eyes;
capturing a first iris image of the subject's first eye;
determining that the first iris image exceeds the image quality metric;
focusing, automatically on a second of the subject's eyes;
capturing a second iris image of the subject's second eye; and
determining that the second iris image exceeds the image quality metric.

17. The method of claim 16, wherein a first focus for the subject's first eye differs from a second focus for the subject's second eye.

18. The method of claim 15, wherein the focusing and capturing comprises:
focusing, automatically on both of the subject's eyes simultaneously; and
capturing the iris image of both of the illuminated subject's eyes simultaneously.

19. The method of claim 15, wherein the face image is captured at a lower resolution than the iris image.

20. The method of claim 15, wherein the subject's eyes are illuminated with more light for iris image capture than the subject's face is illuminated with for face image capture.
